(19) United States
(12) Patent Application Publication
(10) Pub. No.: US 2008/0120398 A1
(43) Pub. Date: May 22, 2008

(54) COMMUNICATION APPARATUS, COMMUNICATION METHOD, AND STORAGE MEDIUM THEREFOR

(75) Inventor: Shigeru Hiroki, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/940,716

(22) Filed: Nov. 15, 2007

(30) Foreign Application Priority Data
Nov. 21, 2006 (JP) 2006-314403

(51) Int. Cl. G06F 15/16

(52) U.S. Cl. 709/219

(57) ABSTRACT

A communication apparatus includes a detecting unit configured to detect that the communication apparatus enters a coverage area of a network, a first storage area configured to store first network identification information, a second storage area configured to store information necessary for accessing a first network from a second network, and a transmitting unit configured to transmit a file to a server on the first network when the detecting unit detects that the communication apparatus has entered a coverage area of the first network identified by the first network identification information and to access the first network on the basis of the information stored in the second storage area and transmit a file to the server on the first network when the detecting unit detects that the communication apparatus has entered a coverage area of the second network.

### BACKGROUND OF THE INVENTION

1. Field of the Invention

The present invention relates to communication apparatuses for transmitting files to servers on networks. The present invention also relates to communication methods and storage media storing computer programs for causing computers to execute the communication methods.

2. Description of the Related Art

Recently, digital cameras having wireless communication functions such as IEEE802.11 wireless LAN have become commercially available. Such digital cameras can use the wireless communication functions to transmit image data stored in storage media to servers on wireless communication networks. For example, a technique has been developed for deleting an image file from a storage medium after the image file is transmitted to a file server (see, Japanese Patent Laid-Open No. 2000-184324).

A technique has also been developed for automatically transmitting a captured image to a file server when it is detected that a digital camera enters a wireless range of a home server (see, Japanese Patent Laid-Open No. 2002-199121).

However, the above techniques do not allow a user either to send an image file to a server of a house of another person or to send an image file to a server of the user's house from a place other than his or her house.

In addition, in many cases, a user does not set wireless communication parameters such as a network identifier, an encryption key, and an authentication scheme which are necessary for wirelessly communicating with a wireless access point (base station device) at a location other than user's house. Thus, when the user communicates with a wireless access point located outside his or her house, the user has to perform operations for setting wireless communication parameters in addition to operations for transmitting an image file.

### SUMMARY OF THE INVENTION

The present invention has been made in view of the above circumstances. Accordingly, there is a need for a technique which can overcome the above problem associated with sending files to servers on networks.

According to an aspect of the present invention, a communication apparatus includes a detecting unit configured to detect that the communication apparatus has entered a coverage area of a network, a first storage area configured to store first network identification information, a second storage area configured to store information for accessing a first network from a second network, and a transmitting unit configured to transmit a file to a server on the first network when the detecting unit detects that the communication apparatus has entered a coverage area of the first network, wherein the first network is identified by the first network identification information, and to access the first network based on the information stored in the second storage area and to transmit a file to the server on the first network when the detecting unit detects that the communication apparatus has entered a coverage area of the second network.

Further features of the present invention will become apparent from the following description of exemplary embodiments with reference to the attached drawings.

### BRIEF DESCRIPTION OF THE DRAWINGS

FIG. 1 illustrates a configuration of a system in which a digital camera according to an exemplary embodiment of the present invention is implemented.

FIG. 2 is a block diagram illustrating a digital camera according to an exemplary embodiment of the present invention.

FIG. 3 is a flowchart illustrating an operation procedure performed by a digital camera according to an exemplary embodiment of the present invention.

FIG. 4 is a flowchart illustrating an operation procedure performed by a digital camera according to an exemplary embodiment of the present invention.

FIG. 5 is a flowchart illustrating an operation procedure performed by a digital camera when a wireless network identifier is set in a home identifier storage area, according to an exemplary embodiment of the present invention.

### DESCRIPTION OF THE EMBODIMENTS

The accompanying drawings, which are incorporated in and constitute a part of the specification, illustrate exemplary embodiments and features of the invention and, together with the description, serve to explain at least some of the principles of the invention.

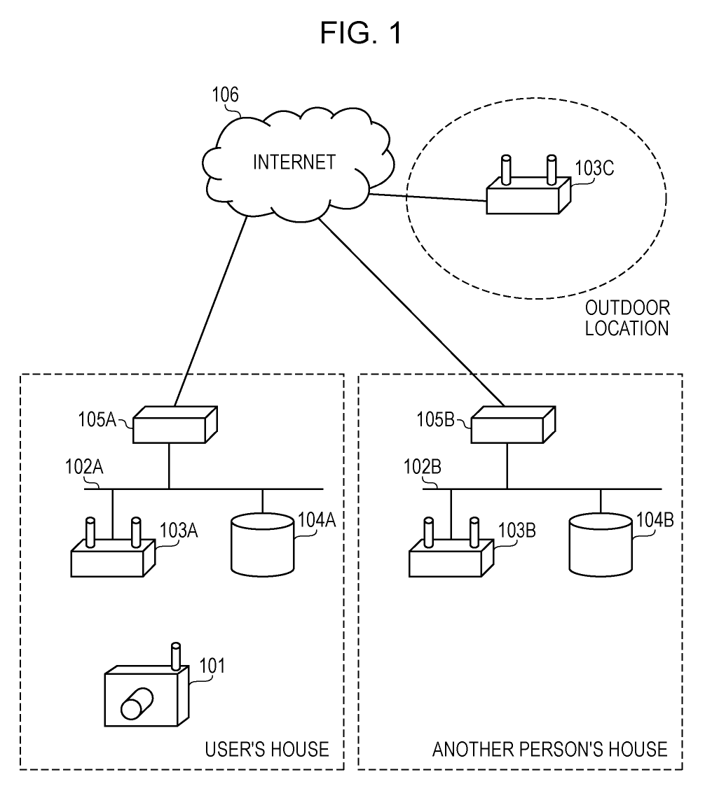

FIG. 1 illustrates a configuration of a system in which a digital camera 101 according to a first exemplary embodiment of the present invention is implemented.

A user of the digital camera 101 can freely move to and from his or her house, a house of another person, and outdoor locations.

In the user's house, several devices are connected to a network 102A which includes an access point 103A of an IEEE802.11 wireless LAN (hereinafter simply referred to as a wireless LAN). The access point 103A forms a wireless network using a wireless network identifier A. The digital camera 101 can be connected to the network 102A by wirelessly communicating with the access point 103A through the wireless LAN.

The user's house also has a file server 104A storing various files such as image files, and a gateway 105A for connecting the network 102A to the Internet 106. The gateway 105A performs firewall control, which allows the Internet 106 to access the devices within the network 102A only when a firewall permits the access.

In the other person's house, devices are connected to a network 102B which includes an access point 103B of a wireless LAN. The access point 103B forms a wireless network using a wireless network identifier B. The digital camera 101 can be connected to the network 102B of the other person's house by wirelessly communicating with the access point 103B through the wireless LAN.

The other person's house also has a file server 104B storing various files such as image files and a gateway 105B connecting the network 102B to the Internet 106. The gateway 105B performs firewall control, which allows the Internet 106 to access the devices within the network 102B only when a firewall permits the access.

In an outdoor location, devices can access the Internet 106 through a public wireless LAN. An access point 103C of the public wireless LAN forms a wireless network using a wireless network identifier C. The digital camera 101 can access the Internet 106 by wirelessly communicating with the access point 103C through the public wireless LAN.

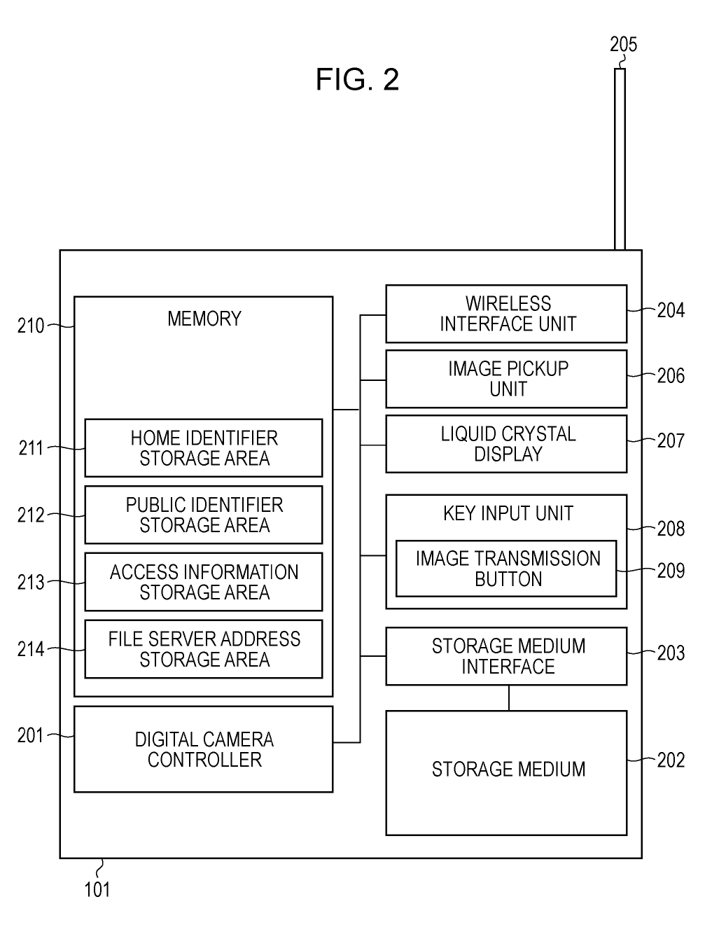

FIG. 2 is a block diagram illustrating a configuration of the digital camera 101 according to the present embodiment.

The digital camera 101 includes a digital camera controller 201 for controlling the digital camera 101, a storage medium 202 for storing data such as an image file corresponding to a captured image, and a storage medium interface 203 which allows the storage medium 202 to be mounted in the body of the digital camera 101. The storage medium 202 may be a compact flash memory card (CF memory card), a secure digital memory card (SD memory card), a hard disk, etc.

The digital camera 101 also includes a wireless interface unit 204 used in performing wireless communication, an antenna 205, an image pickup unit 206, and a liquid crystal display 207.

An image captured by the image pickup unit 206 is processed by the digital camera controller 201 into an image file and stored in the storage medium 202.

In addition, the digital camera 101 includes a key input unit 208 for receiving input from a user of the digital camera 101, and an image transmission button 209 which is provided in the key input unit 208. When the image transmission button 209 is pressed by the user, processing for transmitting an image file stored in the storage medium 202 to a file server is initiated.

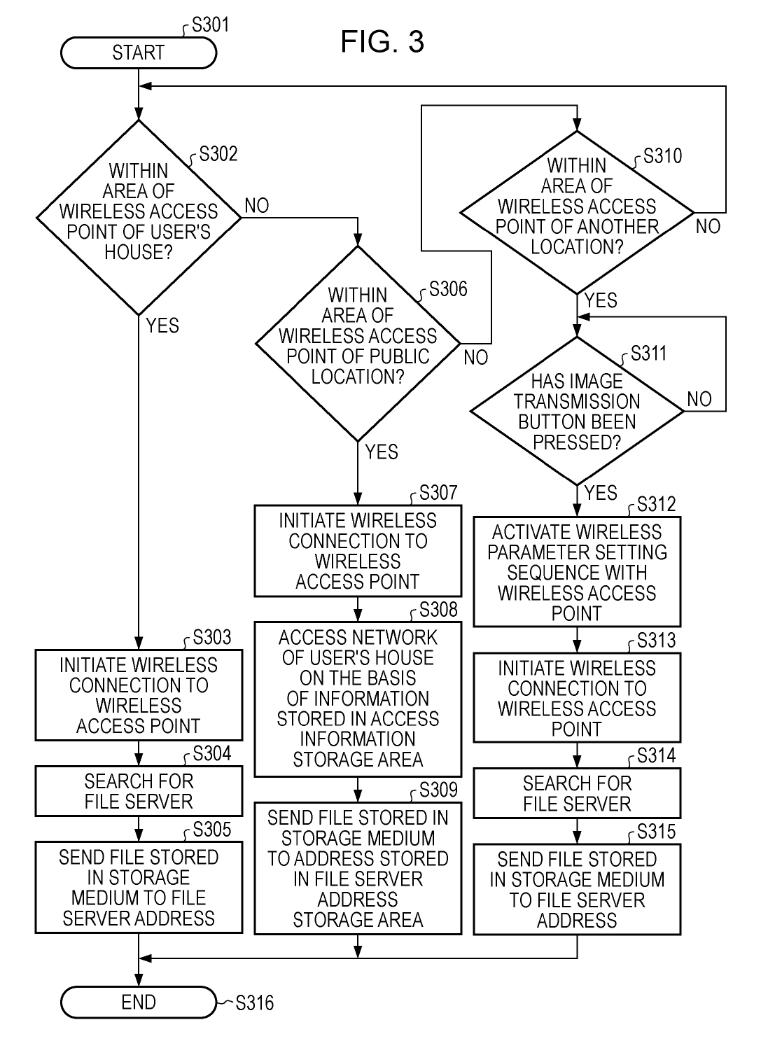

Further, the digital camera 101 has a memory 210 including a home identifier storage area 211, a public identifier storage area 212, an access information storage area 213, and a file server address storage area 214. The home identifier storage area 211 stores a wireless network identifier of the access point 103A of the user's house. The public identifier storage area 212 stores a wireless network identifier of the access point 103C of a public network. The access information storage area 213 stores information necessary for accessing the network 102A of the user's house via the Internet 106. The file server address storage area 214 stores an IP (Internet protocol) address of the file server 104A which is necessary for transmitting a file to the file server 104A via the Internet 106. The memory 210 also stores an operation program in accordance with which the digital camera controller 201 performs control of the entire digital camera 101. The operation program will be described in more detail with reference to FIGS. 3, 4, and 5.

The user of the digital camera 101 sets in advance a value in the home identifier storage area 211, the public identifier storage area 212, the access information storage area 213, and the file server address storage area 214. The user can input the values by pressing keys of the key input unit 208 while visually checking the input values using the liquid crystal display 207.

For example, a wireless network identifier A of the access point 103A of the user's house, e.g., a character string “HOME AP”, is set in the home identifier storage area 211. A wireless network identifier C of the access point 103C of the public wireless LAN, e.g., a character string “PUBLIC SPOT”, is set in the public identifier storage area 212.

Information necessary for accessing from the Internet 106 to the network 102A of the user's house is set in the access information storage area 213. Such information may be, for example, an IP address of the gateway 105A, an encryption scheme, and an encryption key. Thus, a VPN (Virtual Private Network) based on IPsec (Security Architecture for Internet Protocol) can be established between a network and the gateway 105A.

An IP address of the file server 104A of the user's house is set in the file server address storage area 214.

The user of the digital camera 101 sets in advance wireless communication parameters for connecting to the access point 103A of the user's house and the access point 103C of the public LAN. For parameter setting, the user inputs values by pressing the keys of the key input unit 208 while visually checking the input using the liquid crystal display 207.

When the digital camera 101 is capable of automatically setting wireless communication parameters in a wireless terminal by wirelessly communicating with an access point (wireless communication parameter setting sequence), the user can set the wireless communication parameters using the function.

In general, an access point periodically transmits control information called a beacon, so that a wireless terminal detects that it is within the coverage area of the access point. The beacon contains a wireless network identifier of the access point. By analyzing this wireless network identifier contained in the received beacon, the wireless terminal can specify an access point coverage area in which it is located.

FIG. 3 is a flowchart illustrating an operation procedure to be performed by the digital camera 101 according to the present embodiment.

The digital camera 101 periodically searches for a beacon using the wireless interface unit 204 to detect that it has entered an access point coverage area when receiving a beacon.

When the wireless network identifier contained in the received beacon matches a wireless network identifier stored in the home identifier storage area 211 (YES in STEP S302), the process proceeds to STEP S303.

At STEP S303, the digital camera 101 initiates wireless connection to an access point, e.g., the access point 103A of the user's house. Once the wireless connection is established, the digital camera 101 searches for a file server at STEP S304. In the file server search, a search function such as UPnP (Universal Plug and Play) capable of searching for a device within the same network is used.

When a file server is found, e.g., file server 104A), the digital camera 101 transmits a file stored in the storage medium 202 to the file server 104A at STEP S305.

As a result of the above-described process, when the digital camera 101 enters the coverage area of the access point 103A of the user's house, the digital camera 101 automatically transmits files to the file server 104A of the user's house. In addition, since a search function such as UPnP is used for search for a file server, the digital camera 101 need not store an IP address of the file server 104A.

If, in STEP S302, when the wireless network identifier contained in the received beacon does not match a wireless network identifier stored in the home identifier storage area 211, the process proceeds to STEP S306. At STEP S306, when the wireless network identifier in the received beacon matches a wireless network identifier stored in the public identifier storage area 212, the process proceeds to STEP S307.

At STEP S307, the digital camera 101 initiates wireless connection to an access point, e.g., the access point 103C. Once the wireless connection is established, the digital camera 101 accesses the network 102A based on the information set in the access information storage area 213 at STEP S308.

When the IP address of the gateway 105A, encryption scheme, and encryption key are set in the access information storage area 213, the digital camera 101 establishes a VPN connection of IPsec with the gateway 105A. This VPN connection can assure secure file transmission over the Internet 106.

At STEP S309, the digital camera 101 transmits a file stored in the storage medium 202 to a file server address stored in the file server address storage area 214 (in this case, the IP address of the file server 104A of the user's house).

As a result of the above-described process, the digital camera 101 can automatically transmit a file to the file server 104A of a user's house when the digital camera 101 enters the coverage area of the access point 103C of the public wireless LAN. Since the VPN is used in the file transmission, the file can be securely transmitted even from an outdoor location.

When the wireless network identifier in the received beacon does not match any of the wireless network identifiers stored in the home identifier storage area 211 and the public identifier storage area 212 (NO in STEP S302, NO in STEP S306, and YES in STEP S310), the process proceeds to STEP S311.

At STEP S311, the digital camera 101 monitors input of the image transmission button 209. When the digital camera 101 detects user input through the image transmission button 209 (YES in STEP S311), the digital camera 101 activates a wireless communication parameter setting sequence with an access point (in this case, the access point 103B of the other person's house) at STEP S312.

Through the execution of the wireless communication parameter setting sequence, wireless communication parameters necessary for wireless communication with the access point 103B are set in the digital camera 101.

When the wireless communication parameter setting sequence is completed, the digital camera 101 initiates wireless connection to the access point 103B at STEP S313. Once the wireless connection is established, the digital camera 101 searches for a file server at STEP S314. In the file server search, a search function such as UPnP capable of searching for a device within the same network is used.

When a file server is found (in this case, the file server 104B of the other person's house), the digital camera 101 sends a file stored in the storage medium 202 to the file server 104B at STEP S315.

As a result of the above-described process, when the digital camera 101 enters the coverage area of the access point 103B of the other person's house, a user can transmit a file to the file server 104B of the other person's house by pressing the image transmission button 208. This arrangement allows the user to send files to a file server of the house of another person with simple operations. At this time, there is no risk of automatically sending files to the house of another person without user instruction. As described above, according to the present embodiment, transmission of a file to a file server can easily and securely be performed from any of the access point coverage areas of user's house, another person's house, and a public LAN.

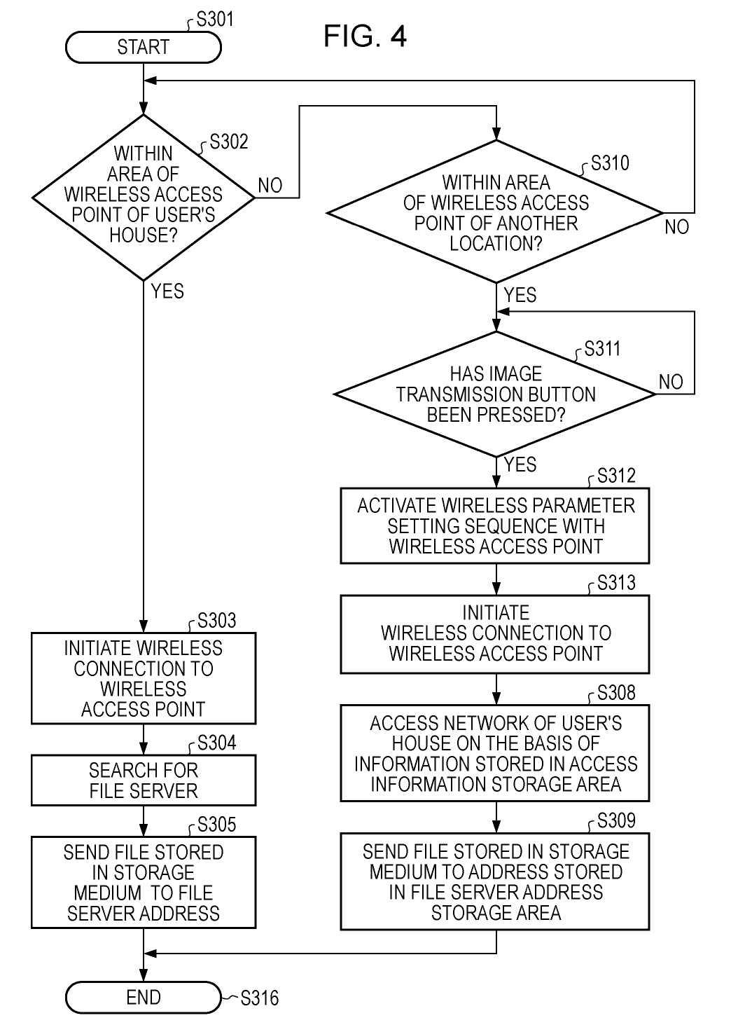

FIG. 4 is a flowchart illustrating an operation procedure performed by the digital camera 101 according to a second exemplary embodiment of the present invention.

In this exemplary embodiment, the same system and device configurations described in the first embodiment are used, and thus a description thereof is omitted. The present embodiment will be described with reference to FIGS. 1, 2, and 4.

The user of the digital camera 101 sets in advance values in the home identifier storage area 211, the access information storage area 213, and the file server address storage area 214, similarly to the first embodiment. However, in the present embodiment, setting of a value in the public identifier storage area 212 is not necessary.

The user of the digital camera 101 also sets in advance wireless communication parameters necessary for wireless communication with the access point 103A of the user's house, similarly to the first embodiment.

Turning to FIG. 4, when a wireless network identifier of a beacon received from an access point matches a wireless network identifier stored in the home identifier storage area 211 (YES in STEP S302), the digital camera 101 proceeds to the same procedure (S303 to S305) as performed in the first embodiment.

When the wireless network identifier of the received beacon does not match the wireless network identifier stored in the home identifier storage area 211 (NO in STEP S302 and YES in STEP S310), the process proceeds to STEP S311.

At STEP S311, the digital camera 101 monitors user input through the image transmission button 209. When the digital camera 101 detects user input of through the image transmission button 209, the process proceeds to STEP S312.

At STEP S312, the digital camera 101 activates a wireless communication parameter setting sequence with an access point (in this case, the access point 103B of the other person's house or the access point 103C of the public wireless LAN).

As a result of the execution of the wireless communication parameter setting sequence, wireless communication parameters necessary for connecting to the access point (in this case, the access point 103B of the other person's house or the access point 103C of the public wireless LAN) are set in the digital camera 101.

When the wireless communication parameter setting sequence is completed, the digital camera 101 initiates wireless connection to the access point (in this case, the access point 103B of the other person's house or the access point 103C of the public LAN) at STEP S313. Once the wireless connection is established, the digital camera 101 accesses the network 102A based on the information stored in the access information storage area 213 at STEP S308.

When the IP address of the gateway 105A, encryption scheme, and encryption key are set in the access information storage area 213, the digital camera 101 establishes a VPN connection of IPsec with the gateway 105A. This VPN connection can assure secure file transmission over the Internet 106.

Then, at STEP S309, the digital camera 101 transmits a file stored in the storage medium 202 to a file server address stored in the file server address storage area 214 (in this case, the IP address of the file server 104A of the user's house).

As a result of the above-described process, the user can transmit a file from the digital camera 101 to the file server 104A of the user's house even when the digital camera 101 is located within the coverage area of the access point 103B of the other person's house. In addition, since VPN is used in the file transmission, the file can securely be transmitted even from the other person's house. As described above, according to the present embodiment, transmission of a file to a file server of the user's house can easily and securely be performed from any of the access point coverage areas of the user's house, another person's house, and a public wireless LAN.

A third exemplary embodiment of the present invention relates to a scheme for automatically setting a wireless network identifier in the home identifier storage area 211, as performed in the first and second embodiments.

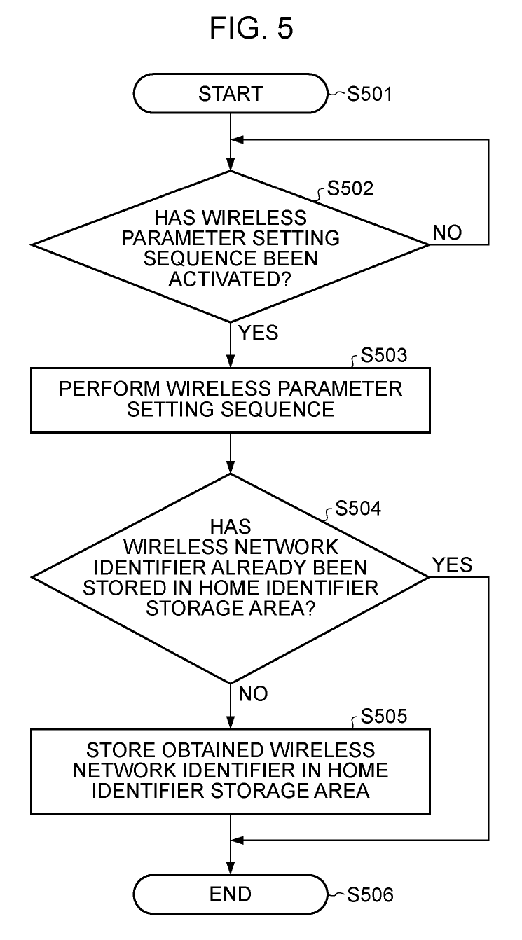

FIG. 5 is a flowchart illustrating an operation procedure performed by the digital camera 101 when a wireless network identifier is set in the home identifier storage area 211 according to the present embodiment.

When a wireless communication parameter setting sequence is activated (YES in STEP S502), the digital camera 101 performs the wireless communication parameter setting sequence at STEP S503. Note that a wireless communication parameter sequence is activated when, for example, the user instructs initiation of wireless communication parameter setting, or when the power of the digital camera 101 is turned on.

When the wireless communication parameter setting sequence is completed, the digital camera 101 determines whether a wireless network identifier has already been stored in the home identifier storage area 211 at STEP S504. When no wireless network identifier has been stored in the home identifier storage area 211 (NO in STEP S504), the digital camera 101 stores a wireless network identifier that is acquired through the above wireless communication parameter setting sequence in the home identifier storage area 211 at STEP S505.

As a result of the above-described process, the digital camera 101 recognizes the access point of a network with which the digital camera 101 has first performed a wireless communication parameter setting sequence as the access point of a user's house. Thus, the digital camera 101 automatically sets the wireless network identifier acquired through the wireless communication parameter sequence in the home identifier storage area 211.

At this time, the digital camera 101 can notify the user of the setting of the wireless network identifier in the home identifier storage area 211 by, for example, displaying a message such as “Do you wish to set this identifier as home identifier?” and stores the wireless network identifier in accordance with a user instruction.

Other than the above-described operational procedure, the operations of the digital camera 101 are similar to those described in the first and second exemplary embodiments.

As described above, the above operations according to third exemplary embodiment allow a wireless network identifier to easily be set in the home identifier storage area 211 while maintaining the functions described in the first and the second embodiments.

According to the above described exemplary embodiments, files stored in a storage medium of a digital camera can easily and securely be transmitted to a file server on a network.

When the digital camera enters a coverage area of a wireless access point of the house of its user, a file is automatically transmitted to a file server of the user's house. This allows the user to manage data files with simple operations. For example, once the user enters his or her house, files in the digital camera are automatically transmitted to the file server of his or her house. Thus, even if the user recognizes that the storage medium of the digital camera runs short of storage capacity when he or she uses the digital camera again on the following day, the user can continue shooting by deleting from the storage medium the files that have already been transmitted to the file server.

In addition, when the capacity of the storage medium becomes insufficient when the user is at an outdoor location, the user sends files to the file server of his or her house by entering a coverage area of a public wireless LAN. This allows the user to continue shooting without worrying about the capacity of the storage medium.

Further, when the user enters a coverage area of an access point of a house of another person, file transmission is not performed without user instruction. Thus, files in the digital camera 101 may not be transmitted to a file server of the other person's house regardless of the user's intention. When the digital camera 101 is within the coverage area of the access point of the other person's house, the user can also transmits a file to any of the file servers of his or her house and the other person's house.

Moreover, when the digital camera 101 enters a coverage area of an access point in which communication is to be performed using a wireless network identifier which is not stored in the digital camera 101, the user can easily set wireless communication parameters necessary for communication with the access point by executing a wireless communication parameter setting sequence.

The present invention is not limited to any specific type of file which can be transmitted via the above-described embodiments. Any file transmission scheme can be applied. For example, it can be configured such that a flag indicating whether a file has been sent is set in each file, and the digital camera 101 transmits only unsent files when it enters the coverage point of an access point. This configuration permits the effective use of communication bands.

It is also possible that files which have been sent to a file server are deleted after a predetermined time period elapses. This arrangement allows a user to continue shooting without worrying about the remaining capacity of the storage medium. At this time, files that have been transmitted to the file server of the user's house may automatically be deleted while files that have been transmitted to a file server of another person's house are maintained in the storage medium. This arrangement can reduce the possibility that files which have erroneously been transmitted to the file server of the other person's house are deleted.

Moreover, flags may be set in files that are not expected to be transmitted to the file server of the other person's house. The user can check the flag so as not to transmit these files. This arrangement can reduce a risk of erroneously transmitting a file which the user does not wish to be viewed by others to the file server of the other person's house.

While the cases in which a digital camera is used in implementing the above described exemplary embodiments have been described above, any device having a wireless communication function, such as a portable music player, a portable game device, a PDA (personal digital assistant), may be employed.

In addition, the case in which an IEEE802.11 wireless LAN is used has been described above. However, the above-described exemplary embodiments may be applied to other wireless communication schemes such as WiMax and iBurst. Further, the above described exemplary embodiments may also be applied not only to a wireless network but also to a wired network.

According to the above-described exemplary embodiments, a file can easily be transmitted to a server on a network from the coverage area of the network as well as the coverage area of another network.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-314403 filed Nov. 21, 2006, which is hereby incorporated by reference herein in its entirety.

What is claimed is:

1. A communication apparatus comprising:
a detecting unit configured to detect that the communication apparatus has entered a coverage area of a network;
a first storage area configured to store first network identification information;
a second storage area configured to store information for accessing a first network from a second network; and
a transmitting unit configured to transmit a file to a server on the first network when the detecting unit detects that the communication apparatus has entered a coverage area of the first network, wherein the first network is identified by the first network identification information, and
to access the first network based on the information stored in the second storage area and transmit a file to the server on the first network when the detecting unit detects that the communication apparatus has entered a coverage area of the second network.

2. The communication apparatus of claim 1, further comprising a searching unit configured to search for a server on a network,
wherein the searching unit searches for a server on the first network when the detecting unit detects that the communication apparatus has entered the coverage area of the first network.

3. The communication apparatus of claim 1,
wherein the first network is a wireless network to which a first access point belongs.

4. The communication apparatus of claim 1, further comprising a third storage area configured to store an address of a server on the first network,
wherein when the detecting unit detects that the communication apparatus has entered the coverage area of the second network, the transmitting unit accesses the first network based on the information stored in the second storage area and transmits a file based on the information stored in the third storage area.

5. The communication apparatus of claim 1, further comprising an instructing unit configured to instruct transmission of a file,
wherein when the detecting unit detects that the communication apparatus has entered a coverage area of a third network, the transmitting unit transmits a file to a server on the third network in accordance with an instruction of the instructing unit.

6. The communication apparatus of claim 1, further comprising an instructing unit configured to instruct transmission of a file,
wherein when the detecting unit detects that the communication apparatus has entered the coverage area of the second network, the transmitting unit accesses the first network based on the information stored in the second storage area in accordance with an instruction of the instruction unit, and transmits a file to the server on the first network.

7. The communication apparatus of claim 1, further comprising a setting unit configured to automatically set a communication parameter for communicating with an access point,
wherein when the detecting unit detects that the communication apparatus has entered the coverage area of the second network, the setting unit sets a communication parameter for communicating with a second access point which belongs to the second network.

8. The communication apparatus of claim 1, further comprising a setting unit configured to automatically set a communication parameter for communicating with an access point,
wherein when the detecting unit detects that the communication apparatus has entered the coverage area of a third network, the setting unit sets a communication parameter for communicating with an access point which belongs to the third network.

9. A method for communicating in which a communication apparatus storing first network identification information and access information for accessing a first network from a second network transmits a file to a server on a network, the method comprising:
transmitting a file to a server on the first network when it is detected that the communication apparatus has entered a coverage area of the first network, wherein the first network is identified by the first network identification information, and
accessing the first network based on the access information and transmitting the file to the server on the first network when it is detected that the communication apparatus has entered a coverage area of the second network.

10. A computer-readable storage medium storing computer-executable process steps, the computer-executable process steps causing a computer to execute the method of claim 9.
